(19) United States
(12) Patent Application Publication
(10) Pub. No.: US 2023/0297935 A1
(43) Pub. Date: Sep. 21, 2023

(54) GOODS TRANSPORTATION SYSTEM AND METHOD

(71) Applicant: Coretex Limited, Auckland (NZ)

(72) Inventors: Steven Mark PERRIN, Alpine, CA (US); Selwyn Lyle PELLETT, Brookby (NZ); Akinyemi Akinbowale KOYI, San Marcos, CA (US)

(21) Appl. No.: 18/186,139

(22) Filed: Mar. 17, 2023

Related U.S. Application Data
(60) Provisional application No. 63/321,092, filed on Mar. 17, 2022.

(51) Int. Cl. G06Q 10/0832; G06Q 10/0835

(52) U.S. Cl. CPC G06Q 10/0832; G06Q 10/08355

(57) ABSTRACT

A goods transportation system and method is described the method comprising obtaining information regarding each of a plurality of refrigerated units; obtaining information regarding each of a plurality of routes; calculating an efficiency metric for each of one or more potential assignments of one or more of the refrigerated units to the plurality of routes based on the information regarding each of the plurality of refrigerated units and the information regarding each of the plurality of routes; selecting one of the one or more potential assignments; and outputting the selected assignment.

### CROSS-REFERENCE TO RELATED APPLICATIONS

The present application claims priority to U.S. Provisional Application No. 63/321,092 filed with the United States Patent and Trademark Office on Mar. 17, 2022 and entitled “GOODS TRANSPORTATION SYSTEM AND METHOD,” which is incorporated herein by reference in its entirety for all purposes.

### FIELD

This invention relates to a goods transportation system and method.

### BACKGROUND

Temperature of perishable goods during storage and transport has a significant impact on the shelf or usable life of the goods. For this reason, goods may be transported in refrigerated units. Refrigerated units may be assigned to service distribution routes within a goods distribution network. It would be desirable to service distribution routes in an efficient way.

### SUMMARY

According to one example embodiment there is provided a method comprising:
obtaining information regarding each of a plurality of refrigerated units;
obtaining information regarding each of a plurality of routes;
calculating an efficiency metric for each of one or more potential assignments of one or more of the refrigerated units to the plurality of routes based on the information regarding each of the plurality of refrigerated units and the information regarding each of the plurality of routes;
selecting one of the one or more potential assignments; and
outputting the selected assignment.

In examples, the method further comprises operating the one or more refrigerated units on the routes according to the selected assignment.

In examples, obtaining information regarding each of a plurality of refrigerated units comprises obtaining information regarding thermal insulation of each refrigerated unit and calculating an efficiency metric comprises calculating the efficiency metric based on the information regarding thermal insulation.

In examples, the information regarding the insulation of each refrigerated unit comprises a heat transfer coefficient and calculating the efficiency metric comprises calculating the efficiency metric based on the heat transfer coefficient.

In examples, obtaining information regarding each of a plurality of refrigerated units comprises obtaining information regarding a refrigeration unit of each refrigerated unit and calculating the efficiency metric comprises calculating the efficiency metric based on the information regarding the refrigeration unit.

In examples, the information regarding the refrigeration unit comprises information on the refrigeration unit efficiency and calculating the efficiency metric comprises calculating the efficiency metric based on the refrigeration unit efficiency.

In examples, the information regarding the refrigeration unit comprises information regarding a type of the refrigeration unit and calculating the efficiency metric comprises calculating the efficiency metric based on the type of the refrigeration unit.

In examples, the information regarding the refrigeration unit comprises information regarding a condition of the refrigeration unit and calculating the efficiency metric comprises calculating the efficiency metric based on the condition of the refrigeration unit.

In examples, the information regarding the refrigeration unit comprises information regarding a maintenance history of the refrigeration unit and calculating the efficiency metric comprises calculating the efficiency metric based on the maintenance history of the refrigeration unit.

In examples, obtaining information regarding each of a plurality of refrigerated units comprises obtaining information regarding a capacity of each of the refrigerated units and calculating the efficiency metric comprises calculating the efficiency metric based on the capacity.

In examples, obtaining information regarding each of a plurality of refrigerated units comprises obtaining information regarding the type of each refrigerated unit and calculating the efficiency metric comprises calculating the efficiency metric based on the type.

In examples, one or more of the plurality of refrigerated units is a refrigerated vehicle.

In examples, one or more of the plurality of refrigerated units is a refrigerated trailer.

In examples, obtaining information regarding the plurality of routes comprises obtaining information regarding an ambient temperature associated with each route and calculating the efficiency metric comprises calculating the efficiency metric based on the ambient temperature.

In examples, obtaining information regarding the plurality of routes comprises obtaining information regarding a required refrigeration temperature range associated with each route and calculating the efficiency metric comprises calculating the efficiency metric based on the required temperature range.

In examples, obtaining information regarding the plurality of routes comprises obtaining information regarding one or more refrigerated unit door opening events associated with reach route and calculating the efficiency metric comprises calculating the efficiency metric based on the door opening events.

In examples, the information regarding the refrigerated unit door opening events comprises a number of refrigerated unit door opening events associated with the route and calculating the efficiency metric comprises calculating the efficiency metric based on the number of door opening events.

In examples, the information regarding the refrigerated unit door opening events comprises information regarding a duration of one or more refrigerated unit door opening events and calculating the efficiency metric comprises calculating the efficiency metric based on the duration of one or more door opening events.

In examples, obtaining information regarding the plurality of routes comprises obtaining information regarding the length of each of the routes and calculating the efficiency metric comprises calculating the efficiency metric based on the length.

In examples, obtaining information regarding the plurality of routes comprises obtaining information regarding a time taken to traverse each of the routes and calculating the efficiency metric comprises calculating the efficiency metric based on the time.

In examples, obtaining information regarding the plurality of routes comprises obtaining information regarding a frozenness requirement for each route and calculating the efficiency metric comprises calculating the efficiency metric based on the frozenness requirement.

In examples, obtaining information regarding the plurality of routes comprises obtaining information regarding a terrain associated with each route and calculating the efficiency metric comprises calculating the efficiency metric based on the terrain.

In examples, obtaining information regarding the plurality of routes comprises obtaining information regarding a possible loss cost associated with each of one or more of the routes and calculating the efficiency metric comprises calculating the efficiency metric based on the possible loss cost.

In examples, the plurality of routes comprises a plurality of groups of routes, each of one or more of the groups of routes being associated with a respective distribution center.

In examples, each of the one or more potential assignments comprises an assignment of one or more of the refrigerated units to each of the groups of routes.

In examples, the method comprises obtaining information regarding each of the distribution centers and calculating the efficiency metric comprises calculating the efficiency metric based on the information regarding each of the distribution centers.

In examples, obtaining information regarding the one or more distribution centers comprises obtaining a geographical location of each distribution center and calculating the efficiency metric comprises calculating the efficiency metric based on the geographic locations.

In examples, the method comprises calculating a cost of relocating a refrigerated unit from one distribution center to another based on the geographic locations and the efficiency metric is based on the cost of relocating the refrigerated unit.

In examples, the method comprises determining an ambient temperature associated with each distribution center based on the geographic locations and calculating the efficiency metric comprises calculating the efficiency metric based on the ambient temperatures.

In examples, the method comprises determining a practicality of relocating a refrigerated unit from one distribution center to another based on the geographic locations and calculating the efficiency metric comprises calculating the efficiency metric based on the practicality.

In examples, the method comprises obtaining information indicative of a required number of refrigerated units associated with each distribution center and calculating the efficiency metric comprises calculating the efficiency metric based on the information indicative of the required number of refrigerated units.

In examples, the method comprises obtaining a remaining service life of each of the plurality of refrigerated units and calculating the efficiency metric comprises calculating the efficiency metric based on the remaining service life.

In examples, the method comprises obtaining a cost associated with re-assigning a refrigerated unit from one route to another route and calculating the efficiency metric comprises calculating the efficiency metric based on the cost associated with re-assigning.

According to another example there is provided a refrigerated unit assignment system comprising:
one or more processors;
memory associated with the one or more processors storing instructions to be executed by the processor; and
an output device,
wherein the processor is programmed to:
obtain information regarding each of a plurality of refrigerated units;
obtain information regarding each of a plurality of routes;
calculate an efficiency metric for each of one or more potential assignments of one or more of the refrigerated units to the plurality of routes based on the information regarding each of the plurality of refrigerated units and the information regarding each of the plurality of routes;
select one of the one or more potential assignments; and
output the selected assignment.

In examples, the processor is programmed to output instructions for controlling the allocation of refrigerated units to arrange for the refrigerated units to be allocated to routes according to the assignment.

In examples, the processor is programmed to obtain information regarding thermal insulation of each refrigerated unit and calculate an efficiency metric based on the information regarding thermal insulation.

In examples, the processor is programmed to obtain information regarding a refrigeration unit of each refrigerated unit and calculate the efficiency metric based on the information regarding the refrigeration unit.

In examples, the information regarding the refrigeration unit comprises information regarding the refrigeration unit efficiency.

In examples, the processor is programmed to obtain information regarding an ambient temperature associated with each route and calculate the efficiency metric based on the information regarding the ambient temperature.

In examples, the processor is programmed to obtain information regarding a required refrigeration temperature range associated with each route and calculate the efficiency metric based on the required temperature range.

In examples, the processor is programmed to obtain information regarding one or more refrigerated unit door opening events associated with each route and calculate the efficiency metric based on the one or more refrigerated unit door opening events.

In examples, the plurality of routes comprises a plurality of groups of routes, each of one or more of the groups of routes being associated with a respective distribution center and the one or more potential assignments comprises an assignment of one or more of the refrigerated units to each of the groups of routes.

In examples, the processor is programmed to obtain information regarding each of the distribution centers and calculate the efficiency metric based on the information regarding each of the distribution centers.

In examples, the processor is programmed to:
obtain information regarding the geographic location of each of the distribution centers; and
calculate the efficiency metric based on the geographic locations.

In examples, the processor is programmed to:
calculate a cost of relocating a refrigerated unit from one distribution center to another based on the geographic locations; and
calculate the efficiency metric based on the cost of relocating the refrigerated unit.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings, which are incorporated in and constitute part of the specification, illustrate embodiments of the invention and, together with the general description of the invention given above and the detailed description of embodiments given below, serve to explain the principles of the invention.

FIG. 1 is a schematic diagram of a refrigerated unit according to one example;

FIG. 2 is a schematic diagram of a distribution system according to one example;

FIG. 3 is an assignment table according to one example;

FIG. 4 is an assignment table according to another example; and

FIG. 5 is a flow chart of a method according to one example.

### DETAILED DESCRIPTION

Refrigerated units can be used to transport goods along routes. A transport operator, for example a distributor or shipper, may employ several refrigerated units together in a fleet and may service several different routes. Several routes may be grouped into a group of routes, and there may be several such groups of routes. Each group of routes may be associated with a distribution center. The distribution center may be a location from which refrigerated units are dispatched to deliver goods along the routes. The distribution centers may be depots at which the refrigerated units may be stored when not in use.

It may be in the interests of a transport operator to improve or maximize the efficiency with which a fleet of refrigerated units services routes. For example, efficiency may relate to a monetary cost of servicing the routes, which an operator may want to reduce or minimize. Different refrigerated units may have different properties from each other, and these different properties may affect the efficiency with which each refrigerated unit can service a given route based on the properties of that route. The operator may want to assign the refrigerated units to the routes in a way that improves or maximizes the overall efficiency with which the fleet services all of the routes. In the case where efficiency relates to monetary cost, this may reduce or minimize the overall cost of servicing all of the routes. Examples provided herein may allow an operator to improve or maximize the overall efficiency with which a fleet of refrigerated units services a plurality of routes.

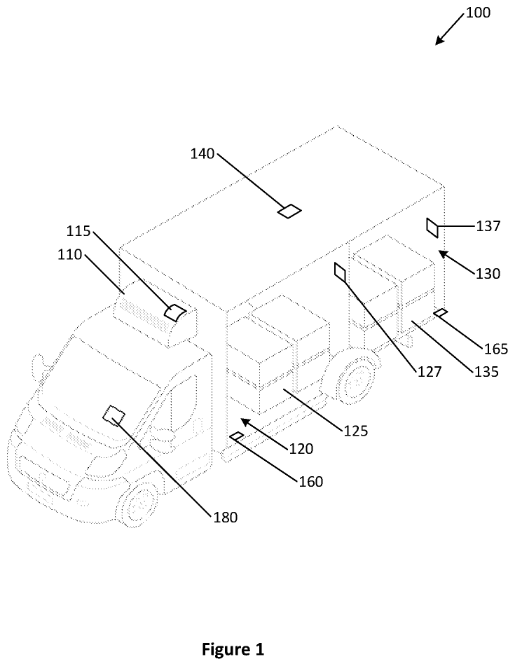

FIG. 1 schematically illustrates a refrigerated unit 100 according to an example embodiment. The refrigerated unit 100 can include one or more compartments for receiving goods. The compartments can be at the same temperature as each other or different temperatures. In this example the refrigerated unit 100 includes two compartments 120 and 130. Goods 125 and 135 are located in the compartments 120 and 130, respectively.

The refrigerated unit 100 may be a mobile refrigerated unit. For example, it could be a refrigerated vehicle or a refrigerated trailer. A refrigerated vehicle or trailer, or a refrigerated compartment thereof, may be known as a “reefer”. In the example of FIG. 1, the refrigerated unit 100 is a refrigerated vehicle in the form of a truck.

The refrigerated unit 100 can include a refrigeration unit 110 for controlling the temperature in the compartment(s) 120 and 130, thereby controlling the temperature of the goods 125 and 135. The refrigeration unit 110 can be arranged to maintain different compartments at different temperatures. For example, the compartment 120 may be maintained about or below a required temperature of 0° Fahrenheit as appropriate for the goods 125 and the compartment 130 may be maintained about or below a required temperature of 38° Fahrenheit as appropriate for the goods 135. Alternatively, two or more separate refrigeration units may be provided to separately control the temperatures of two or more compartments. A refrigeration unit monitor 115 can be provided to monitor operation of the refrigeration unit 110. The refrigeration unit monitor 115 may measure one or more of power consumption of the refrigeration unit 110, temperature and/or flow rate of gases into the refrigeration unit 110 inlet(s), temperature and/or flow rate of gases from the refrigeration unit 110 outlet(s).

A hardware temperature sensor can be provided in each compartment. In this example, hardware temperature sensors 127 and 137 are provided in the compartments 120 and 130, respectively. The hardware temperature sensor(s) may be used to monitor the temperature within each compartment. Based on the output of the sensor(s), the operation of the refrigeration unit(s) can be controlled to keep each compartment at or below a required temperature or within a required temperature range.

One or more environmental sensors 140 can also be provided on the refrigerated unit 100. For example, these may include sensors for monitoring ambient temperature, wind, humidity, air pressure etc.

The refrigerated unit 100 can also include a GPS unit 180. This may be used to guide a driver of the refrigerated unit 100 along an assigned route. The GPS unit 180 may also be used to track the position of the refrigeration unit 100 along the route over time.

The refrigerated unit 100 can also include one or more door monitors. Some refrigerated units include a door for each refrigerated compartment. In the example of FIG. 1, the refrigerated unit 100 includes two doors (not shown), one for providing access to each compartment 120 and 130. The refrigerated unit 100 correspondingly includes two door monitors 160 and 165 for monitoring doors of the compartments 120 and 130, respectively. Each door monitor may detect one or more of a door open state, a door closed state, a door opening event, and/or a door closing event of a respective door. Each door monitor may additionally or alternatively determine a length of time for which a respective door is open. The refrigerated unit 100 can also include one or more other monitors including monitors for monitoring consumption of fuel, for example diesel or electrical energy. This may be particular useful when the refrigerated unit 100 is a vehicle.

Each refrigerated unit can be associated with one or more properties that affect the efficiency with which it can service a given route. The properties may be empirically determined based on measurements of the refrigerated unit, for example using one or more of sensors or monitors 127, 137, 160, 165 and/or 115. Alternatively or additionally, the properties may be manually input, derived from a computer model of the refrigerated unit, received from an external source, or any combination of these. Each property may take a single value, several discrete values, or may be a function of one or more parameters such as time since last service, refrigeration unit power level, and/or required compartment temperature. The refrigerated unit properties may be stored in one or more dedicated databases, in cloud storage, in each distribution center, in each refrigerated unit, and/or elsewhere.

In one example, each refrigerated unit 100 is associated with information about its thermal insulation. This may be an important factor in determining efficiency because the better the insulation is, the less energy a refrigeration unit will need to expend to maintain the refrigeration compartment(s) about or below a required temperature or within a required temperature range, especially when there is a large difference between the ambient temperature and the required temperature. The information about the insulation could relate to the type, thickness, expected (e.g. nominal or derived from a model) efficiency or actual (e.g. empirically determined) efficiency of the insulation. The information regarding the thermal insulation can be a heat transfer coefficient.

Each refrigerated unit 100 can additionally or alternatively be associated with information about its refrigeration unit 110. Different refrigeration units 110 can have different efficiencies. In some cases, an efficiency property, which could be a single value or a function dependent on other variables, could itself be associated with each refrigerated unit 100. Alternatively or additionally, the type of each refrigeration unit 110 can be associated with the refrigerated unit 100. The type of unit may indirectly indicate an efficiency of the refrigeration unit 110 for a given route because some refrigeration units may be more efficient in certain conditions than other refrigeration units are. For example, the information can include information about the type of refrigerant used, whether the refrigeration unit uses one of more cold plates, electric cooling units etc. The condition or maintenance history of the refrigeration unit 110 may similarly be used to indirectly indicate the efficiency of the refrigeration unit 110 for a given route.

The capacity of the refrigerated unit 100 can also be used as an indicator of efficiency for a given route. For example, a route may require a certain volume of goods to be delivered. A given refrigerated unit may have a carrying capacity less than this volume. This refrigerated unit may be relatively inefficient when used to service the route as it may need to make more than one trip to transport all of the goods. Alternatively or additionally, the carrying capacity of the refrigerated unit 100 can include a maximum weight that the refrigerated unit is rated to carry. The efficiency of the refrigerated unit 100 for a given route can be based on a comparison of the maximum rated carrying weight of the refrigerated unit to the weight of goods to be delivered on a route.

Other indicators of efficiency of the refrigerated can be fuel efficiency. This can include efficiency of use of diesel or electrical energy, for example, and can be particularly useful when the refrigerated unit is a vehicle. In the case that the refrigerated unit is a vehicle, the information can also include whether the vehicle includes one or more regenerative energy sources such as hub generators and information about their energy generation capacities.

Information about the temperatures at which the refrigerated unit 100 can operate can also be used to determine the efficiency of the refrigerated unit for a given route. The refrigerated unit 100 can have one or a range of optimal temperatures that it can operate in. These can be absolute values of temperature within a refrigerated compartment 120, 130 of the refrigeration unit 100. Alternatively or additionally, the refrigerated unit 100 can have one or a range of optimal temperature differentials between a refrigerated compartment 120, 130 and the ambient environment that it can operate in. The efficiency of the refrigerated unit 100 for a given route can depend on a comparison of the required temperature for goods on the route and/or an ambient temperature on the route to the refrigerated unit 100 optimal operating temperature(s). The refrigerated unit 100 may have different optimal operating temperatures for each compartment 120, 130. Different types of refrigerated units may have different efficiencies, too. Some refrigerated units may be small trucks, some may be large trucks, some may be trailers. These different types of refrigerated units may be differently efficient for a given route. For example, large trucks may be inefficient for short, urban routes but relatively efficient for long rural routes. Small trucks or trailers may be relatively efficient for short urban routes but relatively inefficient for long rural routes.

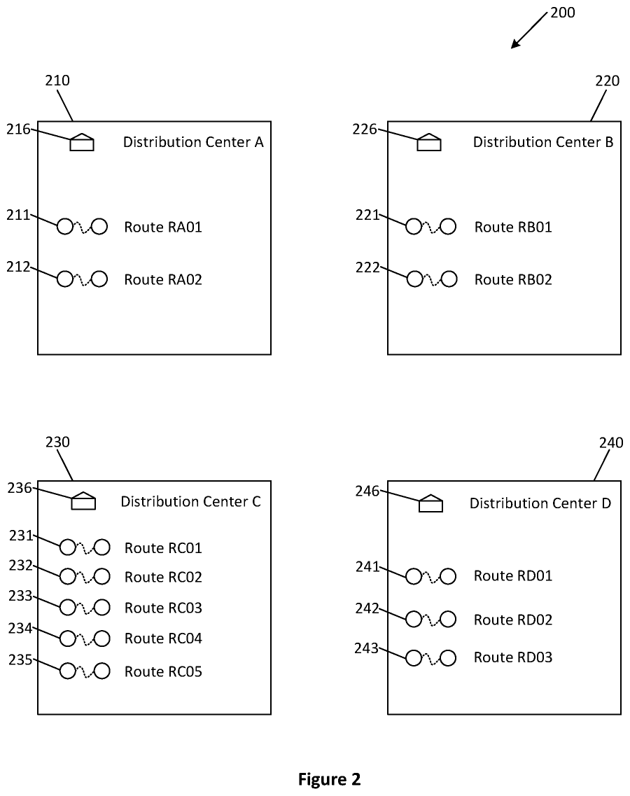

FIG. 2 schematically illustrates an exemplary distribution network 200. The distribution network 200 is made up of routes 211, 212, 221, 222, 231, 232, 233, 234, 235, 241, 242 and 243. In this example, the routes are grouped into four groups of routes 210, 220, 230 and 240. In other examples, the routes need not be so grouped. In this example, each of the groups of routes 210, 220, 230 and 240 is associated with a respective distribution center 216, 226, 236 and 246. Distribution center 216 is associated with the routes 211 and 212 of the group 210; distribution center 226 is associated with the routes 221 and 222 of the group 220; distribution center 236 is associated with the routes 231, 232, 233, 234 and 235 of the group 230; and distribution center 246 is associated with the routes 241, 242 and 243 of the group 240.

Each route can have one or more associated properties that affects the efficiency with which a given refrigerated unit can service that route. The properties may be empirically determined based on measurements taken on the route, for example using sensors or monitors on a refrigerated unit. Measurements taken along the route may be associated with route positions using data from the GPS unit 180. Alternatively or additionally, the properties may be manually input, derived from a computer model of the route, received from an external source, or any combination of these. Each property may take a single value, several discrete values, or may be a function of one or more route parameters such as distance along route, segment of route, time of day, and/or time of year. The route properties may be stored in one or more dedicated databases, in cloud storage, in each distribution center, in each refrigerated unit, and/or elsewhere. In some cases, a location associated with each route may be used to determine one or more other properties of that route. For example, the location of a route may be input to a weather service or database to determine an ambient temperature for that route.

For example, each route may have one or more ambient temperatures typically encountered on the route. These can affect the efficiency with which a refrigerated unit can service the route because the energy consumption of a refrigeration unit will depend on the difference between the ambient temperature and the required temperature or temperature range of its refrigerated compartment(s), among other things. Humidity levels associated with a route can also affect the efficiency and can be taken into account. The temperature, humidity and/or other weather or climate properties of the route can be obtained from weather or climate services, for example weather forecasts. These can provide weather or climate information at the global, national, local or hyperlocal level. This information may include forecasts that can be used to predict the future conditions associated with one or more routes. For example, seasonal variations can be taken into account to determine a season-dependent route allocation with seasonal shifting of refrigerated units.

Another property associated with each route can be the number of times a door of the refrigerated unit is to be opened along the route. Another property can be the length of time a door may be opened for along the route. This can be length of time of each individual opening and/or the total length of time that the door is open for on the route. Door opening affects efficiency because opening the door can allow refrigerated air to escape and ambient air to enter the refrigerated compartment(s), which in turn may require the refrigeration unit to expend more energy maintaining the compartment at, or returning the compartment to, the required temperature or temperature range.

Each route can also have an associated required temperature or temperature range. For example, some routes may require transported goods to be kept about or below 0° Fahrenheit; other routes may require transported goods to be kept about or below 38° Fahrenheit. This can affect the efficiency because a refrigeration unit may expend more energy refrigerating to a lower temperature than to a higher temperature. This route property may be particularly useful when the difference between the ambient temperature is also taken into account, as the energy expenditure of the refrigeration unit would typically depend on the difference between these two temperatures.

Some routes may require goods to be frozen and others may not. This requirement for frozenness of the goods can also be a relevant property when determining efficiency.

Different routes may have difference possible costs associated with loss of goods on the respective routes. For example, some routes may involve the transportation of relatively expensive goods. These routes may have a higher possible loss cost that other routes which involve the transportation of relatively inexpensive goods.

Other properties associated with the route that can be taken into account when determining efficiency include the time taken to traverse the route, the length of the route, the travel speed(s) along the route, the terrain along the route, traffic levels (historical or forecast), fuel costs associated with the route (for example prices or diesel or electrical energy), loaded product temperature, warehouse and dock time, warehouse temperature, and any tolls present along the route (for example possible highway tolls that depend on the weight or number of axles of a vehicle/trailer). Optimal refuel times and/or locations for a refrigerated unit traversing a route (or being transported between distributions centers) can be calculated based on accessibility of refueling stations and fuel costs associated with the refueling stations. These can be obtained from fuel cost bulletin boards or reports from refrigerated unit operators, for example.

Additionally, consumer feedback can be taken into account when determining the properties of a refrigerated unit or its suitability for a given route. This may include information about consumers' satisfaction with products delivered by the refrigerated units.

The groups of routes 210, 220, 230 and 240 in the exemplary distribution network 200 can be grouped by geographic location. For example, the different distribution centers 216, 226, 236 and 246 can be located in different towns, cities, counties, states or countries and can be associated with routes in or near those towns, cities, counties, states or countries.

In some cases, information at the level of the distribution center may be useful in determining the efficiency of an assignment of refrigerated units to routes. For example, an ambient temperature property for a distribution center may be used as the ambient temperature property for each route associated with that distribution center. In some cases, the ambient temperature or other properties associated with the distribution center may be determined based on the geographic location of the distribution center.

In some cases, the geographic location of two distribution centers may be used to derive factors relevant to the efficiency of an assignment of refrigerated units to routes. For example, in some cases potential assignment would have a refrigerated unit that is currently assigned to a route associated with one distribution center re-assigned to different route associated with a different distribution center. This could require transporting the refrigerated unit between the two distribution centers. Optimally, this may be done as part of normal movement of refrigerated units on the network. For example, a refrigerated unit to be transported to a different distribution center could be assigned to a route that ends near the distribution center than it is to be transported to. This refrigerated unit can service the route then carry on to the new distribution center. The refrigerated unit may even service a route associated with the distribution center to which it is being transported along the way. Factors such as the distance between the two distribution centers and/or the time taken to transport the refrigerated unit from one distribution center to the other may be taken into account when determining the efficiency of the potential assignment. More generally, a cost may be incurred in transporting the refrigerated unit and may be factored into the determination of the efficiency of the potential assignment. These costs could include special transport costs such as a shipping cost for transporting a refrigerated unit over a body of water.

Another factor that could be taken into account could include a practicality consideration in transporting the refrigerated unit. For example, two distribution centers may be connected only by a road that is not recommended for heavy transport and which may not be suitable for transporting the refrigerated unit.

Also, distribution centers may have a minimum number of refrigerated units required to be associated with them. This can be taken into account to ensure that a potential assignment satisfies the minimum refrigerated unit number requirements of the distribution centers.

There may also be an inherent cost associated with re-assigning a refrigerated unit from one route to another, for example due to associated paperwork, retraining of personnel, etc. This can also be factored in when calculating the efficiency of a potential assignment.

The remaining service life of a refrigerated unit can also be used to calculate the efficiency of a potential assignment. If a potential assignment would require some cost to be incurred (such as transport cost or route re-assignment cost). If the remaining service life of a refrigerated unit is short, it may not be able to operate on its newly-assigned route for long enough to make up these costs.

Other properties that may affect efficiency of an assignment include how often refrigerated units are used or the ratio of how much time they spend in use to how long they sit idle for. In some cases, it may be more efficient to operate refrigerated units more frequently or at a higher use ratio, for example to reduce storage fees. In other cases, it may be more efficient to reduce the usage of a subset of the refrigerated units as low as possible (preferably to zero) so that those refrigerated units can be sold or otherwise removed from the fleet.

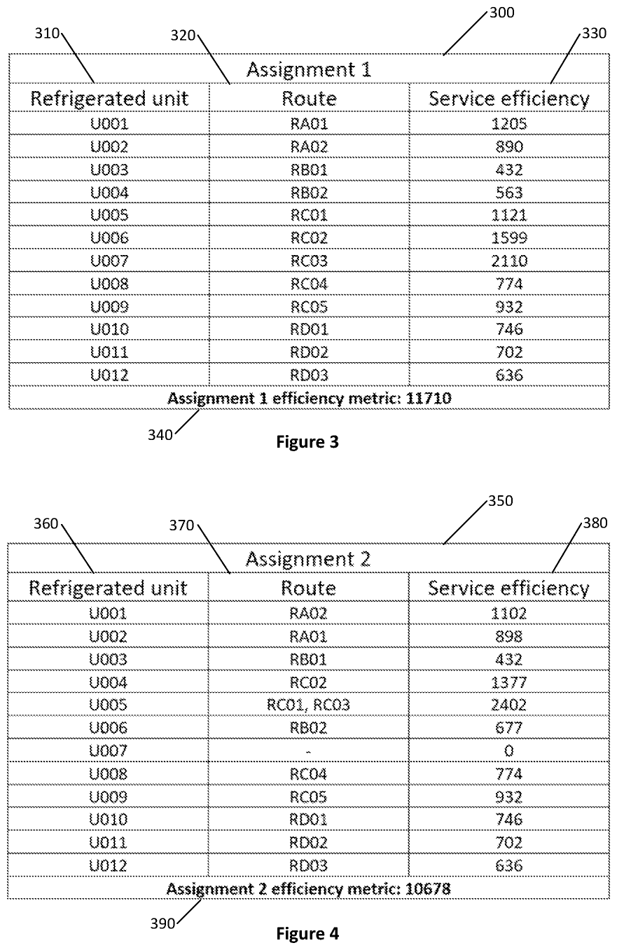

FIGS. 3 and 4 show two potential assignments 300 and 350, respectively.

In Assignment 1 300, refrigerated units U001-U012 of column 310 are assigned to routes RA01-RD03 of column 320, respectively. A service efficiency metric, shown in column 330, is associated with each combination of route and refrigerated unit of this assignment 300. In one example, the service efficiency metric may be expressed in terms of a cost of servicing a given route with a given refrigerated unit per unit time (e.g. dollars per week). The sum of all of the service efficiency metric is expressed as an overall efficiency metric for the potential assignment 300 in cell 340. In this scheme, a high metric implies low efficiency and vice-versa. A scheme having a high metric imply high efficiency and a low metric low efficiency could alternatively be implemented.

It can be seen that the service efficiency for refrigerated unit U006 to service route RCO2 is quite high—1599 units. It could be that route RCO2 is associated with a high ambient temperature and refrigerated unit U006 has poor insulation. It can also be seen that routes RB01 and RB02 both have relatively low service efficiency metrics. It could be that these routes are in areas with low ambient temperatures.

Assignment 2 350 differs from Assignment 1 300 in that refrigerated unit U006 is now assigned to route RB02 and refrigerated unit U004 is now assigned to route RCO2. Refrigerated unit U004 is able to service route RCO2 with an efficiency metric of 1377, significantly better than refrigerated unit U006 was able to. While refrigerated unit U006 is slightly less efficient at servicing route RB02 than unit U004 was, this is more than made up for by the improved efficiency of unit U004 servicing route RCO2. In this respect, Assignment 2 350 is more efficient than Assignment 1 300.

Another difference of Assignment 2 350 compared to Assignment 1 300 is that refrigerated unit U005 now services route RC03, in addition to route RC01. Refrigerated unit U007, which serviced route RCO3 in Assignment 1 300, is no longer assigned to any route.

It can be seen in Assignment 1 300 that the service efficiency metric of refrigerated unit U007 servicing route RCO3 was very high—2110. This could be because the insulation of refrigerated unit U007 is particularly poor, or the refrigeration unit is in poor condition, for example. In Assignment 2 350, refrigerated unit U005 is able to service both routes RCO1 and RC03 much more efficiently than units U005 and U007 were able to separately service routes RCO1 and RC03.

Comparing the efficiency metrics 340 and 390 of the assignments 300 and 350, it can be seen that Assignment 2 350 is significantly more efficient than Assignment 1 300, with an efficiency metric 1032 units less. In the scenario in which the efficiency metric is representative of a monetary cost of operating according to the assignment, this would translate to significant cost savings when operating according to Assignment 2 350 rather than Assignment 1 300.

The efficiency metric can be representative of other measures of efficiency such as greenhouse gas emissions (expressed in terms of mass of carbon or otherwise), energy consumption, product assurance, consumer satisfaction, other pertinent metrics, or combinations thereof. Aggregated efficiency values for all routes associated with a distribution center can also be used to determine a distribution center performance score. Distribution center performance can be predicted based on projected efficiency of the population of refrigerated units servicing the set of routes associated with the distribution center.

Based on the efficiencies for the assignments, the method can include automatically nominating a ranked list of refrigeration unit-to-route assignments and determining the overall efficiency, impact on distribution center performance and/or product assurance for each potential assignment.

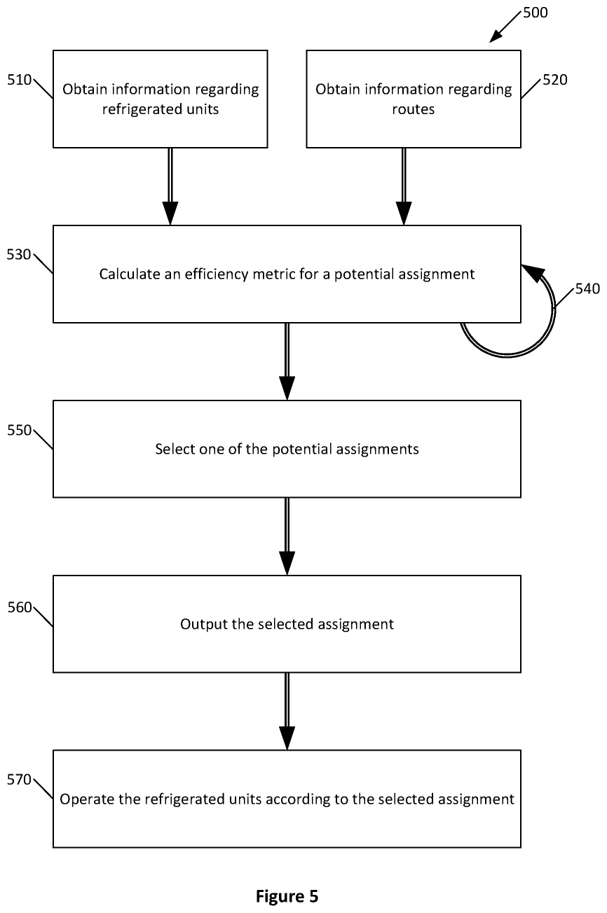

FIG. 5 is a flow chart of an exemplary method 500. Information regarding the refrigerated units is obtained at step 510. Information regarding the routes is obtained at step 520. An efficiency metric for a potential assignment is then calculated based on this information in step 530. The method can then return to step 530 at loop 540 if to calculate the efficiency of other potential assignments. If no further potential assignments are to be assessed, the method moves to step 550 in which one of the potential assignments is selected. The method may calculate the efficiency of every possible potential assignment and only move on once all potential assignments are assessed. Alternatively, the method may move on to step 550 when a predetermined number of assignments have been assessed at step 530, after a predetermined amount of time, or after a potential assignment with a sufficiently good efficiency metric has been found, for example.

At step 550, the potential assignment with the best efficiency metric may be selected. Alternatively, a set of potential assignments with good efficiency metrics may be presented to a user to select between. At step 560, the selected potential assignment is output. This may involve displaying the potential assignment on a screen, recording it onto a recording medium, transmitting it to a fleet controller, controlling the allocation of refrigerated units to arrange for the refrigerated units to be allocated to routes or another output operation. Controlling the allocation of refrigerated units to arrange for the refrigerated units to be allocated to routes can include arranging for the relocation of refrigerated units to the appropriate distribution center. The refrigerated units can then be operated according to the selected assignment in step 570.

Interpretation

A number of methods have been described above. It will be appreciated that any of these methods may be embodied by a series of instructions, which may form a computer program. These instructions, or this computer program, may be stored on a computer readable medium, which may be non-transitory. When executed, these instructions or this program may cause a processor, such as a CPU or GPU, to perform the described methods.

Where an approach has been described as being implemented by a processor, this may comprise a plurality of processors. That is, at least in the case of processors, the singular should be interpreted as including the plural. Where methods comprise multiple steps, different steps or different parts of a step may be performed by different processors.

The order of steps within methods may be altered, such that steps are performed out of order or in parallel, except where one step is dependent on another having been performed, or the context otherwise requires.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A method comprising:
obtaining information regarding each of a plurality of refrigerated units;
obtaining information regarding each of a plurality of routes;
calculating an efficiency metric for each of one or more potential assignments of one or more of the refrigerated units to the plurality of routes based on the information regarding each of the plurality of refrigerated units and the information regarding each of the plurality of routes;
selecting one of the one or more potential assignments; and
outputting the selected assignment.

2. The method of claim 1, further comprising operating the one or more refrigerated units on the routes according to the selected assignment.

3. The method of claim 1, wherein obtaining information regarding each of a plurality of refrigerated units comprises obtaining information regarding thermal insulation of each refrigerated unit and wherein calculating an efficiency metric comprises calculating the efficiency metric based on the information regarding thermal insulation.

4. The method of claim 1, wherein obtaining information regarding each of a plurality of refrigerated units comprises obtaining information regarding a refrigeration unit of each refrigerated unit and wherein calculating the efficiency metric comprises calculating the efficiency metric based on the information regarding the refrigeration unit.

5. The method of claim 1, wherein obtaining information regarding the plurality of routes comprises obtaining information regarding an ambient temperature associated with each route and wherein calculating the efficiency metric comprises calculating the efficiency metric based on the ambient temperature.

6. The method of claim 1, wherein obtaining information regarding the plurality of routes comprises obtaining information regarding a required refrigeration temperature range associated with each route and wherein calculating the efficiency metric comprises calculating the efficiency metric based on the required temperature range.

7. The method of claim 6, wherein obtaining information regarding the plurality of routes comprises obtaining information regarding one or more refrigerated unit door opening events associated with each route and wherein calculating the efficiency metric comprises calculating the efficiency metric based on the door opening events.

8. The method of claim 7, wherein the information regarding the refrigerated unit door opening events comprises information regarding a duration of one or more refrigerated unit door opening events and wherein calculating the efficiency metric comprises calculating the efficiency metric based on the duration of one or more door opening events.

9. The method of claim 1, wherein obtaining information regarding the plurality of routes comprises obtaining information regarding a frozenness requirement for each route and wherein calculating the efficiency metric comprises calculating the efficiency metric based on the frozenness requirement.

10. The method of claim 1, wherein obtaining information regarding the plurality of routes comprises obtaining information regarding a possible loss cost associated with each of one or more of the routes and wherein calculating the efficiency metric comprises calculating the efficiency metric based on the possible loss cost.

11. The method of claim 1, wherein the plurality of routes comprises a plurality of groups of routes, each of one or more of the groups of routes being associated with a respective distribution center, wherein each of the one or more potential assignments comprises an assignment of one or more of the refrigerated units to each of the groups of routes, wherein the method comprises obtaining information regarding each of the distribution centers, and wherein calculating the efficiency metric comprises calculating the efficiency metric based on the information regarding each of the distribution centers.

12. The method of claim 11, wherein obtaining information regarding the one or more distribution centers comprises obtaining a geographical location of each distribution center and wherein calculating the efficiency metric comprises calculating the efficiency metric based on the geographic locations, the method further comprising determining a practicality of relocating a refrigerated unit from one distribution center to another based on the geographic locations, and wherein calculating the efficiency metric comprises calculating the efficiency metric based on the practicality.

13. A refrigerated unit assignment system comprising:
one or more processors;
memory associated with the one or more processors storing instructions to be executed by the processor; and
an output device,
wherein the processor is programmed to:
obtain information regarding each of a plurality of refrigerated units;
obtain information regarding each of a plurality of routes;
calculate an efficiency metric for each of one or more potential assignments of one or more of the refrigerated units to the plurality of routes based on the information regarding each of the plurality of refrigerated units and the information regarding each of the plurality of routes;
select one of the one or more potential assignments; and
output the selected assignment.

14. The refrigerated unit assignment system of claim 13, wherein the processor is programmed to output instructions for controlling the allocation of refrigerated units to arrange for the refrigerated units to be allocated to routes according to the assignment.

15. The refrigerated unit assignment system of claim 13, wherein the processor is programmed to obtain information regarding an ambient temperature associated with each route and calculate the efficiency metric based on the information regarding the ambient temperature.

16. The refrigerated unit assignment system of claim 13, wherein the processor is programmed to obtain information regarding a required refrigeration temperature range associated with each route and calculate the efficiency metric based on the required temperature range.

17. The refrigerated unit assignment system of claim 13, wherein the processor is programmed to obtain information regarding one or more refrigerated unit door opening events associated with each route and calculate the efficiency metric based on the one or more refrigerated unit door opening events.

18. The refrigerated unit assignment system of claim 13, wherein the plurality of routes comprises a plurality of groups of routes, each of one or more of the groups of routes being associated with a respective distribution center and wherein the one or more potential assignments comprises an assignment of one or more of the refrigerated units to each of the groups of routes.

19. The refrigerated unit assignment system of claim 18, wherein the processor is programmed to:
obtain information regarding each of the distribution centers; and
calculate the efficiency metric based on the information regarding each of the distribution centers.

20. The refrigerated unit assignment system of claim 19, wherein the processor is programmed to:
obtain information regarding the geographic location of each of the distribution centers;
calculate the efficiency metric based on the geographic locations;
calculate a cost of relocating a refrigerated unit from one distribution center to another based on the geographic locations; and
calculate the efficiency metric based on the cost of relocating the refrigerated unit.
